(19) United States
(12) Patent Application Publication
(10) Pub. No.: US 2026/0023518 A1
(43) Pub. Date: Jan. 22, 2026

(54) INFORMATION PROCESSING APPARATUS THAT ENABLES USER TO QUICKLY UNDERSTAND WHETHER OR NOT IMAGE FORMING APPARATUS BEING SUBJECT OF FIXED-CHARGE SERVICE CONTRACT IS CAPABLE OF BEING USED UNDER THE SERVICE CONTRACT, INFORMATION PROCESSING SYSTEM, CONTROL METHOD FOR INFORMATION PROCESSING APPARATUS, AND STORAGE MEDIUM

(71) Applicant: CANON KABUSHIKI KAISHA, Tokyo (JP)

(72) Inventor: JUMPEI TAKEICHI, Kanagawa (JP)

(21) Appl. No.: 19/230,901

(22) Filed: Jun. 6, 2025

(30) Foreign Application Priority Data
Jul. 19, 2024 (JP) 2024-115676

(51) Int. Cl. G06F 3/12

(52) U.S. Cl. CPC G06F 3/1269; G06F 3/1204

(57) ABSTRACT

An information processing apparatus enabling a user to quickly understand whether or not an image forming apparatus, which is a subject of a fixed-charge service contract, is capable of being used under the service contract, is provided. The information processing apparatus that is communicably connected to an image forming apparatus, which has a printing function and is a subject of a fixed-charge service contract, includes a control unit that controls communication with the image forming apparatus, a requesting unit that, in a case where contract information relating to the service contract has not been obtained after a predetermined screen is displayed, requests the image forming apparatus to transmit the contract information, a receiving unit configured to receive the contract information transmitted from the image forming apparatus in accordance with the request made by the requesting unit, and a notifying unit configured to notify a contract state of the service contract.

### BACKGROUND

### Field of the Technology

The present disclosure relates to an information processing apparatus, an information processing system, a control method for the information processing apparatus, and a storage medium.

### Description of the Related Art

A printing apparatus having a communication function is capable of transmitting information such as device information and a user usage history to a management server. This makes it possible to provide various kinds of services between the printing apparatus and the management server, such as defect analysis and billing. In addition, other services include a service in which the management server manages consumables such as ink used in the printing apparatus, and in the case where the remaining amount of the consumables becomes low, new consumables are delivered to the location where the printing apparatus has been installed. In addition, in recent years, there has been a trend toward the introduction of subscription contracts. A subscription contract is capable of providing a service in which a printing apparatus and consumables are rented out to a user who has made the subscription contract at a fixed charge, thereby reducing initial investment and maintenance costs. In such a subscription contract, the printing apparatus communicates with a management server to obtain contract information such as the status of the subscription contract from the management server. Furthermore, the printing apparatus is able to perform operations according to the contract information. Specifically, for example, use of the printing apparatus is restricted until service authentication, which confirms a state where the subscription contract has been made, is completed. In addition, it is preferable that a mobile terminal (a terminal apparatus), which issues an instruction for printing or the like to the printing apparatus, obtains contract status information from the printing apparatus and notifies the status of whether the service authentication has been completed or not. For example, Japanese Laid-Open Patent Publication (kokai) No. 2022-140056 has described a subscription service in which consumables are provided from a server side to a recording apparatus (a printing apparatus) side. In this subscription service, in the case where the server does not have a reception history of information on whether or not delivery of a consumable item is required, the server communicates with the recording apparatus to rewrite the reception history, making it possible to arrange for the delivery of the consumable item.

However, in the subscription service described in Japanese Laid-Open Patent Publication (kokai) No. 2022-140056, the contract information of the subscription service is not notified to the user. Therefore, the user is not able to understand (know) whether or not functions executable in the subscription service are available for use.

### SUMMARY

The present disclosure provides an information processing apparatus that enables a user to quickly understand whether or not an image forming apparatus, which is a subject of a fixed-charge service contract, is capable of being used under the service contract, an information processing system, a control method for the information processing apparatus, and a storage medium.

Accordingly, a first aspect of the present disclosure provides an information processing apparatus that is communicably connected to an image forming apparatus, which has a printing function and is a subject of a fixed-charge service contract, the information processing apparatus comprising at least one processor, a memory coupled to the processor storing instructions that, when executed by the processor, cause the processor to function as a control unit that controls communication with the image forming apparatus, and a requesting unit that, in a case where contract information relating to the service contract has not been obtained after a predetermined screen is displayed, requests the image forming apparatus to transmit the contract information, a receiving unit configured to receive the contract information transmitted from the image forming apparatus in accordance with the request made by the requesting unit, and a notifying unit configured to notify a contract state of the service contract.

Accordingly, a second aspect of the present disclosure provides an information processing system comprising an image forming apparatus that has a printing function and is a subject of a fixed-charge service contract, and an information processing apparatus that is communicably connected to the image forming apparatus. The information processing apparatus comprises at least one processor, a memory coupled to the processor storing instructions that, when executed by the processor, cause the processor to function as a control unit that controls communication with the image forming apparatus, and a requesting unit that, in a case where contract information relating to the service contract has not been obtained after a predetermined screen is displayed, requests the image forming apparatus to transmit the contract information, a receiving unit configured to receive the contract information transmitted from the image forming apparatus in accordance with the request made by the requesting unit, and a notifying unit configured to notify a contract state of the service contract.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram that illustrates a schematic configuration of an information processing system according to a first embodiment.

FIG. 2 is a block diagram that illustrates an example of a hardware configuration of a terminal apparatus included in the information processing system illustrated in FIG. 1.

FIG. 3 is a flowchart that illustrates a processing executed by the terminal apparatus.

FIG. 4 is a screen displayed on the terminal apparatus during execution of a program based on the flowchart illustrated in FIG. 3.

FIG. 5A and FIG. 5B are screens displayed on the terminal apparatus during the execution of the program based on the flowchart illustrated in FIG. 3.

FIGS. 6A, 6B, and 6C are screens displayed on the terminal apparatus during the execution of the program based on the flowchart illustrated in FIG. 3.

FIG. 7 is a flowchart that illustrates a processing executed by a terminal apparatus according to a second embodiment.

FIG. 8 is a screen displayed on the terminal apparatus during execution of a program based on the flowchart illustrated in FIG. 7.

### DESCRIPTION OF THE EMBODIMENTS

The present disclosure will now be described in detail below with reference to the accompanying drawings showing embodiments thereof.

Hereinafter, each embodiment of the present disclosure will be described in detail with reference to the drawings. However, the configuration described in each embodiment below is merely an example, and the scope of the present disclosure is not limited by the configuration described in each embodiment. For example, each unit (each component) constituting the present disclosure can be replaced with a unit (a component) with any configuration that can perform the same function(s). In addition, any component(s) may be added. Furthermore, any two or more configurations (features) of each embodiment can be combined.

### First Embodiment

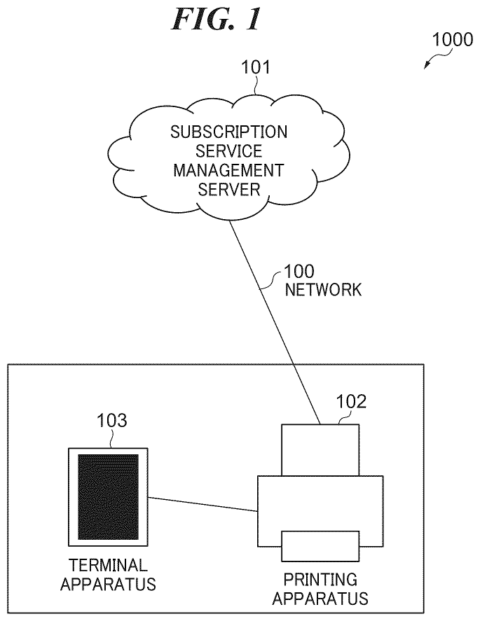

A first embodiment of the present disclosure will be described below with reference to FIGS. 1 to 6C. FIG. 1 is a schematic diagram that illustrates a schematic configuration of an information processing system according to the first embodiment. As shown in FIG. 1, an information processing system 1000 includes a subscription service management server 101, a printing 102, and a terminal apparatus 103. The printing apparatus 102 and the terminal apparatus 103 are connected to each other wirelessly or via wires so that they are capable of communicating with each other, and are capable of being used, for example, within the same building. The subscription service management server 101 and the printing apparatus 102 are connected to each other via a network 100 so as to be able to communicate with each other. The network 100 is not particularly limited, and may be, for example, the Internet, a local area network (a LAN), a wide area network (a WAN), a telephone line, a dedicated digital line, an asynchronous transfer mode (an ATM), or any combination of these.

In the first embodiment, a description will be given of confirming contract information relating to a fixed-charge service contract, that is, a subscription contract (hereinafter, simply referred to as “contract information”), on the information processing system 1000. In the first embodiment, the printing apparatus 102 is a multi-functional peripheral (an image forming apparatus) that has (includes) a plurality of functions including a printing function, but is not limited to a multi-functional peripheral (an MFP) and may be any apparatus as long as it has at least a printing function. The printing apparatus 102 is a subject of the fixed-charge service contract (the subscription contract). In addition, some functions of the plurality of functions included in the printing apparatus 102 are restricted under the service contract. Furthermore, under the service contract, when using the printing apparatus 102, the printing apparatus 102 is used by paying a monthly fee, rather than purchasing and using the printing apparatus 102 itself. The use of the printing apparatus 102 for which a monthly fee is paid is not particularly limited, and examples of the use of the printing apparatus 102 include the use of ink and printing paper (printing sheets) that are incidental to the use of the printing apparatus 102, and the use of a certain amount of ink and printing paper (printing sheets) within the monthly fee. Such an available mode is referred to as “a main body subscription service”.

The subscription service management server 101 is a server that manages the contract information. The subscription service management server 101 is capable of transmitting, to the printing apparatus 102, contract information that has been associated with the printing apparatus 102, based on identification information of the printing apparatus 102. It should be noted that the subscription service management server 101 may manage a part replacement service in the case where part(s) constituting the printing apparatus 102 break down, or the like.

The printing apparatus 102 is an apparatus that is a subject of the service contract. The determination as to whether or not the printing apparatus 102 is an apparatus that is a subject of the service contract is made, for example, based on the identification information for identifying the printing apparatus 102, such as a media access control address (a MAC address) of the printing apparatus 102, a model number of the printing apparatus 102, or a serial number of the printing apparatus 102. Alternatively, the printing apparatus 102 may carry information indicating that the printing apparatus 102 is an apparatus that is a subject of the service contract, and the determination may be made based on this information. The functions of the printing apparatus 102 are restricted until a contract state is capable of being confirmed based on the contract information transmitted from the subscription service management server 101. In addition, in the case where a user has attempted to use the restricted function, an error message is notified by the printing apparatus 102. The content of the error message is not particularly limited, and examples of the error message may include an error message indicating that the use of functions has been restricted due to being not the contract state. Furthermore, in the case where the contract state has been confirmed, the contract information is stored, and the functions, which have been restricted until the contract state is confirmed, are changed to a usable state. The contract state (a status) included in the contract information may be, for example, contracted (under contract), not yet contracted (not under contract), contract information not yet received, contract information being received, contract forcibly suspended, or purchased. In the first embodiment, the contract state will be described as two cases: contracted and not yet contracted. It should be noted that “contract information not yet received” refers to a state in which the contract information has not yet been received. “Contract information being received” refers to a state in which communication with the subscription service management server 101 is being performed. “Contract forcibly suspended” refers to a state in which the contract has been terminated due to some cause. “Purchased” refers to a state in which the printing apparatus 102 is purchased by the user and the ownership of the printing apparatus 102 is transferred from the service provider to the user. In addition, in the case of “purchased”, the printing apparatus 102 is excluded from the subject of the service contract.

An application for using the printing apparatus 102 is installed in the terminal apparatus 103. With the terminal apparatus 103, it is possible to select the printing apparatus 102 on the application. The application is capable of performing setup and function execution of the printing apparatus 102. “The function execution” refers to, by pressing a function execution button on the application, causing the printing apparatus 102 to execute a function corresponding to the function execution button. For example, in the case where a print button has been pressed, a printing instruction is issued to the printing apparatus 102, and printing is capable of being performed by the printing apparatus 102. In addition, in the case where as the function execution, various kinds of information such as ink information of the printing apparatus 102 is obtained and the printing apparatus 102 has a scanning function, it is possible to execute the scanning function. In the first embodiment, after the printing apparatus 102 has been selected with the terminal apparatus 103, the function execution with respect to the printing apparatus 102 is performed, but the present disclosure is not limited to this. For example, the printing apparatus 102 may be selected when the function execution is performed. In addition, until it is capable of being confirmed that the contract state is “contracted”, execution buttons for the restricted functions of the printing apparatus 102 may be displayed in a grayed-out state or may be hidden. As a result, selection of the execution buttons is prohibited. In addition, in a state in which the functions of the printing apparatus 102 have been restricted, in the case where the user has instructed the execution of the restricted function of the printing apparatus 102, an error message is notified by an output device 206 of the terminal apparatus 103. The content of the error message is not particularly limited, and examples of the error message may include an error message indicating that the use of functions has been restricted due to being not the contract state. In addition, the error message may be printed by the printing apparatus 102.

As described above, the subscription service management server 101 and the printing apparatus 102 are connected so as to be able to communicate with each other. The printing apparatus 102 requests the contract information from the subscription service management server 101. It should be noted that a timing for requesting the contract information is not particularly limited, and may be, for example, a timing when the network setup of the printing apparatus 102 is completed and the communication with the subscription service management server 101 has become possible. Furthermore, in response to the request for the contract information, the subscription service management server 101 transmits the contract information to the printing apparatus 102. The printing apparatus 102 receives the contract information from the subscription service management server 101 and saves the received contract information. It should be noted that in the case where the printing apparatus 102 is unable to obtain the contract information (the contract information has not been obtained by the printing apparatus 102), the printing apparatus 102 may periodically request the contract information from the subscription service management server 101. In addition, in the case where the contract state (the status) based on the contract information of the printing apparatus 102 is “under service contract”, the restrictions on the functions of the printing apparatus 102 are lifted.

In addition, the printing apparatus 102 and the terminal apparatus 103 are also connected to each other so as to be able to communicate with each other. In the case where it has been confirmed on the terminal apparatus 103 that the printing apparatus 102 is a model that supports the main body subscription service (a main body subscription service supported model), the terminal apparatus 103 requests the contract information from the printing apparatus 102. In response to this request, the printing apparatus 102 transmits the contract information to the terminal apparatus 103. The terminal apparatus 103 receives and saves the contract information from the printing apparatus 102, and is capable of notifying the user of the contract information as necessary.

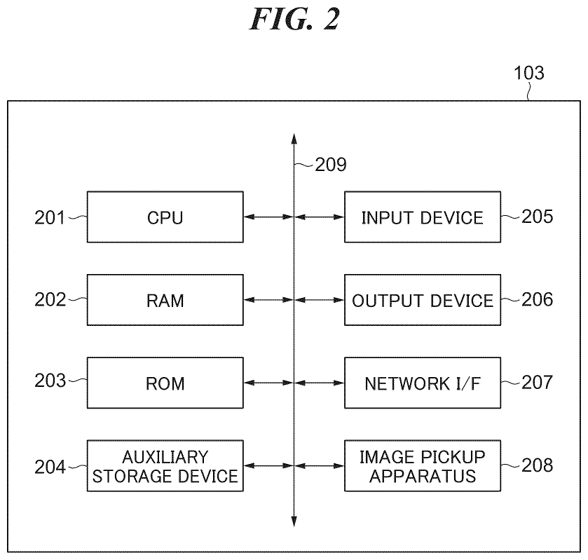

FIG. 2 is a block diagram that illustrates an example of a hardware configuration of the terminal apparatus included in the information processing system illustrated in FIG. 1. As shown in FIG. 2, the terminal apparatus 103 includes a central processing unit (a CPU) 201, a random access memory (a RAM) 202, and a read only memory (a ROM) 203. In addition, the terminal apparatus 103 includes an auxiliary storage device (a storage unit) 204, an input device (an operation unit) 205, the output device (a notifying unit) 206, a network interface (a network I/F) 207, and an image pickup apparatus 208. These pieces of hardware included in the terminal apparatus 103 are connected to each other via a bus 209 so as to be able to communicate with each other. It should be noted that the terminal apparatus 103 may be configured such that any one of the input device 205, the output device 206, and the image pickup apparatus 208 is omitted. The CPU 201 is the central processing unit (a computer) that controls various kinds of operations of the terminal apparatus 103. The RAM 202 is a main storage memory for the CPU 201, and is also used as a working area, or a temporary storage area for loading various kinds of programs. The ROM 203 stores a program (for example, a basic input/output system (a BIOS)) for controlling the operations of the terminal apparatus 103, etc.

The auxiliary storage device 204 stores an operating system (an OS), which is basic software, programs for various kinds of application and the like, various kinds of data, etc. It should be noted that the applications are not particularly limited, and include, for example, programs or the like for causing the CPU 201 to execute respective units and respective steps (a control method for an information processing apparatus) of the terminal apparatus 103 (the information processing apparatus). In addition, the auxiliary storage device 204 is not particularly limited, and may be, for example, a nonvolatile memory or the like such as a hard disk drive (an HDD) or a solid state drive (an SSD). The input device 205 is a device for accepting instructions from a user who uses the terminal apparatus 103. The input device 205 is not particularly limited, and may include, for example, a keyboard, a touch panel, and/or a pointing device such as a mouse. The output device 206 is a device for presenting various kinds of information and the like to the user. The output device 206 is not particularly limited, and may be, for example, a display device such as a liquid crystal display. The network I/F 207 is an interface that is connected to a predetermined network (such as a LAN or the Internet) and is used to communicate with external device(s) via the predetermined network. The image pickup apparatus 208 is an apparatus that includes an image pickup device (not shown) and converts an image photographed by the image pickup device (an imaging sensor) into digital data. This digital data is temporarily stored in the RAM 202. Thereafter, the digital data is converted into a predetermined image format by a program executed by the CPU 201 and is saved (stored) in the auxiliary storage device 204 as image data. It should be noted that the terminal apparatus 103 is not particularly limited, and may be, for example, an information processing apparatus such as a desktop or notebook personal computer, a tablet terminal, or a smartphone.

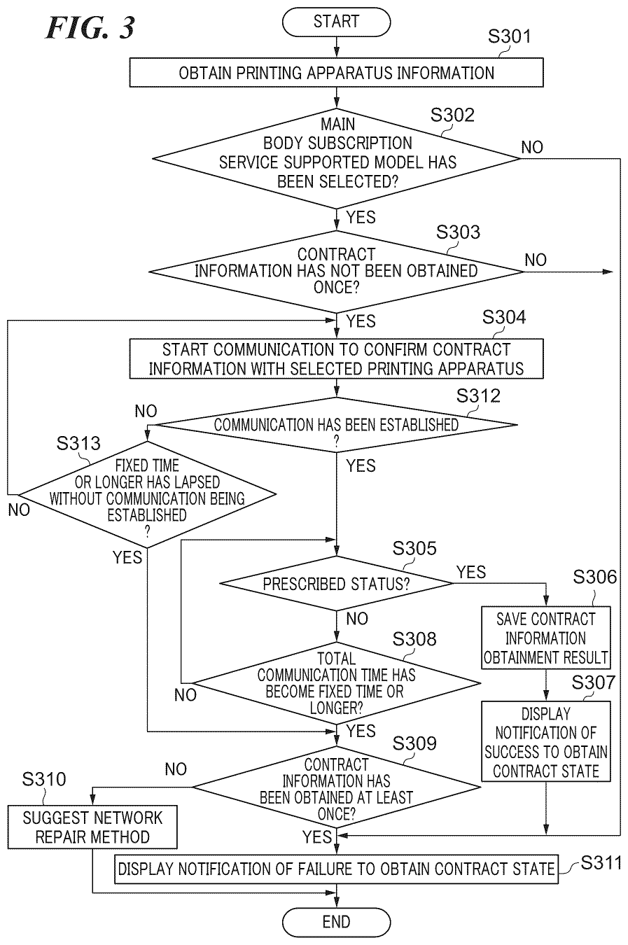

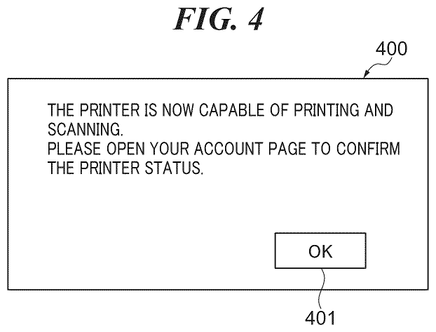

FIG. 3 is a flowchart that illustrates a processing executed by the terminal apparatus. A program based on the flowchart illustrated in FIG. 3 has been stored in, for example, the ROM 203 or the auxiliary storage device 204, and is loaded into the RAM 202 by the CPU 201 and is executed by the CPU 201. In addition, in the first embodiment, the program based on the flowchart illustrated in FIG. 3 is executed in the case where a home screen (a predetermined screen) of the application (a printer driver) is displayed on the output device 206. “The home screen” refers to the first screen that is always displayed when the application is activated. In addition, in the first embodiment, it is assumed that in the case where the printing apparatus 102 has already been registered in the application of the terminal apparatus 103, the home screen is displayed in a state in which the printing apparatus 102 has been selected. It should be noted that as another example of the timing of execution of the program based on the flowchart illustrated in FIG. 3, it may be when the application is activated. In addition, a button such as a subscription service contract information obtaining button may be provided, and the execution is performed in response to a user operation. In addition, in the first embodiment, the printing apparatus 102, which is the main body subscription service supported model, has been registered after the network setup is completed by the application of the terminal apparatus 103. Here, “registration” refers to becoming a state in which the printing apparatus 102 and the terminal apparatus 103 are capable of communicating with each other via the application. Specifically, “registration” refers to obtaining a communication protocol for the printing apparatus 102 and an internet protocol address (an IP address) of the printing apparatus 102, and becoming a communication possible state. Furthermore, it is assumed that the home screen of the application is displayed and that the printing apparatus 102 and the terminal apparatus 103 are capable of communicating with each other. FIGS. 4, 5A, 5B, 6A, 6B, and 6C are screens displayed on the terminal apparatus during the execution of the program based on the flowchart illustrated in FIG. 3, respectively.

As shown in FIG. 3, in a step S301, when obtaining printing apparatus information from the printing apparatus 102, the CPU 201 makes a request to the printing apparatus 102 via the network I/F 207 using the communication protocol and information about the IP address (IP address information). In this way, in the first embodiment, the CPU 201 has a function as a control unit that performs control of communication with the printing apparatus 102 via the network I/F 207 (a control step). The CPU 201 has received (obtained) the printing apparatus information from the printing apparatus 102 via the network I/F 207, and then saves the printing apparatus information in the auxiliary storage device 204. For example, this printing apparatus information includes information such as a name of the printing apparatus 102, the model number and the serial number of the printing apparatus 102, and the MAC address. In addition, the printing apparatus information may include information about functions capable of being executed by the printing apparatus 102, network information for the printing apparatus 102, setting information of the printing apparatus 102, and a printing type of the printing apparatus 102. The printing type may be, for example, information on differences in printing methods such as inkjet printing and laser printing, or information on how to distinguish between small size printing and large size printing. It should be noted that in the case where the printing apparatus information has already been saved in the auxiliary storage device 204, the CPU 201 detects whether or not the printing apparatus information is present within the auxiliary storage device 204, and if the CPU 201 detects that the printing apparatus information is present within the auxiliary storage device 204, it is possible to omit the step S301. After the step S301 is executed, the processing proceeds to a step S302.

In the step S302, the CPU 201 determines whether or not the printing apparatus 102 that has been selected by the application is a main body subscription service supported model. For example, in the first embodiment, this determination is made based on the model number of the printing apparatus 102 included in the printing apparatus information. Then, as a result of the determination in the step S302, in the case of being determined that the printing apparatus 102 that has been selected by the application is a main body subscription service supported model, the processing proceeds to a step S303. On the other hand, as the result of the determination in the step S302, in the case of being determined that the printing apparatus 102 that has been selected by the application is not a main body subscription service supported model, the processing ends.

In the step S303, the CPU 201 determines whether or not the contract information has not been obtained once. As a result of the determination in the step S303, in the case of being determined that the contract information has not been obtained once, the processing proceeds to a step S304. On the other hand, as the result of the determination in the step S303, in the case of being determined that the contract information has been obtained, the processing ends. In this way, in the first embodiment, the CPU 201 has a function as an obtainment determining unit that, in the case where the home screen is displayed, determines whether or not the contract information has been obtained. It should be noted that in the terminal apparatus 103, a part having the function as the obtainment determining unit may be provided separately from the CPU 201. In addition, the contract information may be written once into the RAM 202 when obtained and then saved in the auxiliary storage device 204, or may already be saved in the ROM 203. In this case, the CPU 201 is able to determine whether or not the contract information has been obtained based on the presence or absence of the contract information at a save destination of the contract information.

In the step S304, the CPU 201 issues a command to start communication for confirming the contract information with the printing apparatus 102 via the network I/F 207. This command is issued by transmitting a request for the contract information from the terminal apparatus 103 to the printing apparatus 102 via the network I/F 207 (a requesting step). In this way, in the first embodiment, the CPU 201 has a function as a requesting unit that requests the printing apparatus 102 to transmit the contract information. It should be noted that in the terminal apparatus 103, a part having the function as the requesting unit may be provided separately from the CPU 201. After requesting the contract information, the CPU 201 waits in a receiving state until the contract information according to the request is capable of being received by the network I/F 207 (a receiving unit) (a receiving step) or until a fixed time (a fixed period of time) has elapsed. This “fixed time” is the maximum time to wait in the receiving state in one communication, and in the first embodiment, for example, is set to ten seconds. It should be noted that in the case where the contract information is not capable of being confirmed, the functions of the printing apparatus 102 are not capable of being used, that is, it is not possible to cause to execute the functions of the printing apparatus 102. Therefore, during this communication, moving to another screen or a cancel operation, within the application is prohibited, but the present disclosure is not limited to this. For example, communication for confirming the contract information may continue in the background even in the case where the user moves to another screen, or communication may continue even in the case where the application itself moves to the background. After the step S304 is executed, the processing proceeds to a step S312.

In the step S312, the CPU 201 determines whether or not the communication commanded to start in the step S304 has been established. As a result of the determination in the step S312, in the case of being determined that the communication commanded to start in the step S304 has been established, the processing proceeds to a step S305. On the other hand, as the result of the determination in the step S312, in the case of being determined that the communication commanded to start in the step S304 has not been established, the processing proceeds to a step S313.

In the step S313, the CPU 201 determines whether or not a fixed time or longer (a fixed period of time or longer) has elapsed without the communication being established. As a result of the determination in the step S313, in the case of being determined that the fixed time or longer has elapsed without the communication being established, the processing proceeds to a step S309. On the other hand, as the result of the determination in the step S313, in the case of being determined that the fixed time or longer has not elapsed without the communication being established, the processing returns to the step S304, and the subsequent steps are executed in order. In other words, after commanding the start of the communication and requesting the contract information in the step S304, the request for the contract information is repeated until the communication is established or until the fixed time has elapsed. This “fixed time” is the maximum time to try to establish the communication, and in the first embodiment, as with the maximum time to wait in the receiving state in one communication that has been described above, for example, is set to ten seconds.

In the step S305, the CPU 201 determines whether or not the subscription contract is in a prescribed contract state (a prescribed status), such as under contract, based on the contract information that has been received as a response to the request transmitted in the step S304. In this way, in the first embodiment, the CPU 201 has a function as a state determining unit that determines whether or not the subscription contract is in the prescribed contract state. It should be noted that in the terminal apparatus 103, a part having the function as the state determining unit may be provided separately from the CPU 201. As described above, for example, the contract states include contracted (under contract), and not yet contracted (not under contract). As a result of the determination in the step S305, in the case of being determined that the subscription contract is in the prescribed contract state (here, “contracted”), the processing proceeds to a step S306. On the other hand, as the result of the determination in the step S305, in the case of being determined that the subscription contract is not in the prescribed contract state, or in the case where the fixed time has elapsed, the processing proceeds to a step S308.

In the step S306, the CPU 201 saves, in the auxiliary storage device 204, information indicating that the subscription contract is in the prescribed contract state. After the step S306 is executed, the processing proceeds to a step S307.

In the step S307, the CPU 201 ends the communication with the printing apparatus 102. In addition, when the communication with the printing apparatus 102 ends, the CPU 201 causes the output device 206 to display a notification of a success to obtain the contract state, indicating that the subscription contract is in the prescribed contract state when the communication with the printing apparatus 102 ends, that is, the CPU 201 notifies, on the output device 206, the notification of the success to obtain the contract state (a notifying step). As a result, the user is able to understand (know) the success to obtain the contract state. It should be noted that the notification of the success to obtain the contract state on the output device 206 may be a dialog display, or may be a message display in a notification area of the output device 206. In the first embodiment, an image 400 shown in FIG. 4 is displayed on the output device 206. The image 400 is a dialog that notifies that some functions (for example, the printing function and the scanning function), which have been restricted under the subscription contract, are now capable of being used on the printing apparatus 102. This dialog may include the contents of the subscription agreement. In addition, the image 400 includes an OK button 401. By operating (pressing) the OK button 401, an account page provided by the subscription service management server 101 is capable of being opened on the output device 206. On the account page, for example, the user is able to confirm the contract information of the printing apparatus 102, request the delivery of ink or printing paper (printing sheets), confirm the user's account information, request a replacement of the printing apparatus 102, and view a handbook for making various kinds of inquiries. It should be noted that the contract information of the printing apparatus 102 is not the contract information obtained from the printing apparatus 102 but is the contract information itself managed by the subscription service management server 101. In addition, the account page may be provided by another server (an account page providing server) that is capable of communicating with the subscription service management server 101. In this case, the contract information provided by the account page is information that the subscription service management server 101 has obtained from the account page providing server. In the case where the OK button 401 is operated, the image 400 is closed and the user may be able to use the printing apparatus 102 as is.

In the step S308, the CPU 201 determines whether or not a total communication time since the communication has been started in the step S304 has reached a fixed time (a predetermined time) or more (has become the fixed time (the predetermined time) or longer), that is, the CPU 201 determines whether or not the fixed time (the predetermined time) has elapsed. As a result of the determination in the step S308, in the case of being determined that the total communication time has reached the fixed time or more, the processing proceeds to the step S309. On the other hand, as the result of the determination in the step S308, in the case of being determined that the total communication time has not reached the fixed time or more, the processing returns to the step S305, and the subsequent steps are executed in order. It should be noted that the determination in the step S308 is made as to whether or not the total communication time has reached the fixed time or more, but the present disclosure is not limited to this, and, for example, the determination in the step S308 may be made as to whether or not the number of times the contract information is requested again has reached a predetermined number of times, that is, the determination in the step S308 may be made as to whether or not the number of times of retries has reached an upper limit value.

In the step S309, the CPU 201 ends the communication with the printing apparatus 102 and determines whether or not the contract information has been obtained through the communication with the printing apparatus 102 at least once. As a result of the determination in the step S309, in the case of being determined that the contract information has been obtained through the communication with the printing apparatus 102 at least once, the processing proceeds to a step S311. This contract information includes information indicating that the contract state is not yet contracted. On the other hand, as the result of the determination in the step S309, in the case of being determined that the contract information has not been obtained through the communication with the printing apparatus 102 even once, the processing proceeds to a step S310.

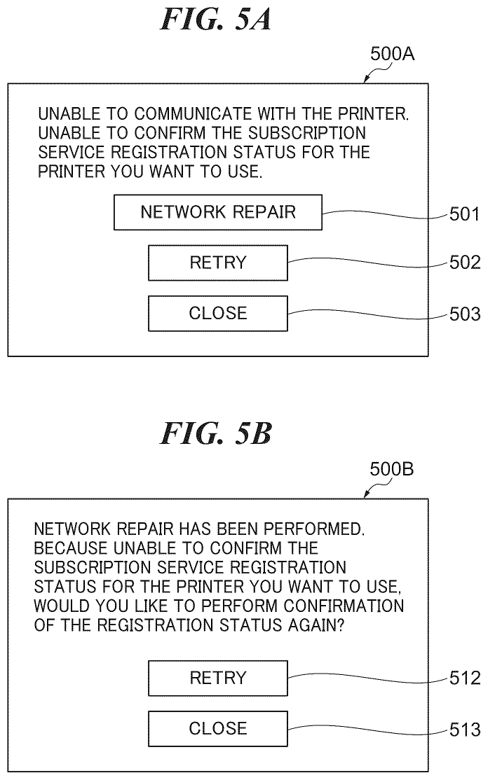

In the step S310, based on the result of the determination in the step S309 that the contract information from the printing apparatus 102 has not been obtained even once, the CPU 201 presumes that a communication network between the terminal apparatus 103 and the printing apparatus 102 has not been established. Then, the CPU 201 causes the output device 206 to display a repair method for repairing the communication network between the terminal apparatus 103 and the printing apparatus 102. In the first embodiment, a screen 500A shown in FIG. 5A is displayed on the output device 206. The screen 500A is a dialog that notifies that the communication network between the terminal apparatus 103 and the printing apparatus 102 has not been established. In addition, the screen 500A includes a network repair button 501, a retry button 502, and a close button 503. By pressing the network repair button 501, a list of repair methods for repairing the communication network between the terminal apparatus 103 and the printing apparatus 102 is displayed on the output device 206. These repair methods are not particularly limited, and may include, for example, restarting the terminal apparatus 103 and the printing apparatus 102, restarting an access point for the printing apparatus 102, and confirming whether or not the terminal apparatus 103 and the printing apparatus 102 are on the same network. In the case where at least one of these repair methods is executed by the user, that is, in the case where an operation to instruct execution of a repair method is performed via the input device 205, the CPU 201 performs a processing of searching for the printing apparatus 102. It should be noted that the determination as to whether or not at least one of these repair methods has been executed is made based on, for example, whether or not a predetermined button has been operated after the execution of the repair method. The CPU 201 determines whether or not the printing apparatus 102 that is the target of the connection setting has been detected, and in the case where the printing apparatus 102 has been detected, the CPU 201 re-registers the printing apparatus 102 and updates the communication protocol and the IP address information. The processing can then resume from the step S301. In the case where the processing has resumed from the step S301, a screen 500B shown in FIG. 5B is displayed. The screen 500B is a dialog that notifies that the repair of the communication network between the terminal apparatus 103 and the printing apparatus 102 is completed (an execution result of the repair method), and prompts the user to reconfirm the contract state of the subscription service contract. In the case where the printing apparatus 102 that is the target of the connection setting does not exist, the CPU 201 ends the processing and displays the screen 500A on the output device 206 again. The screen 500B includes a retry button 512 having a function similar to the retry button 502 on the screen 500A, and a close button 513 having a function similar to the close button 503 on the screen 500A. By operating the retry button 502, the processing resumes from the step S304. In addition, by operating the close button 503, the screen 500A is capable of being closed.

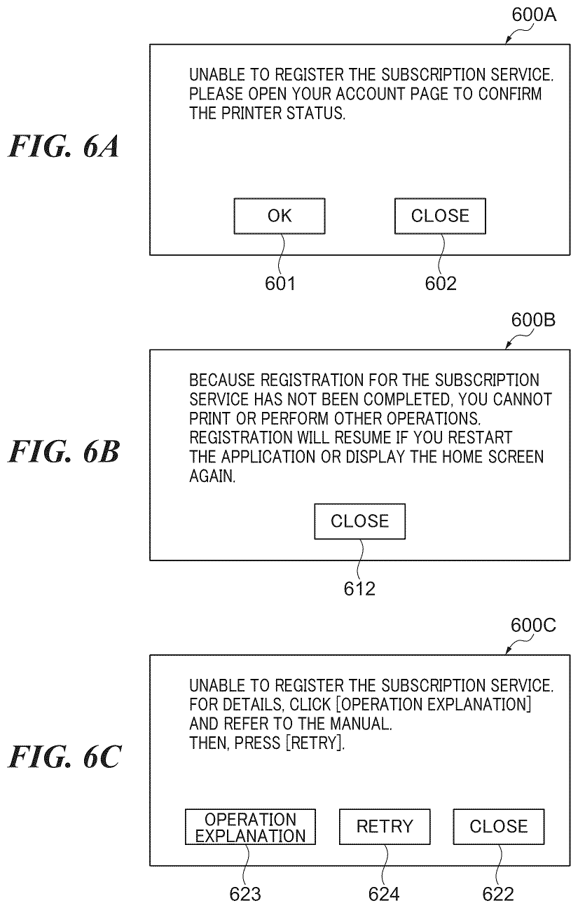

In the step S311, the CPU 201 causes the output device 206 to display a notification of a failure to obtain the contract state, indicating that the contract state when the communication with the printing apparatus 102 ends is not “contracted”, that is, the contract state when the communication with the printing apparatus 102 ends is “not yet contracted” (a notifying step). As a result, the user is able to understand (know) the failure to obtain the contract state. It should be noted that the notification of the failure to obtain the contract state on the output device 206 may be a dialog display, or may be a message display in the notification area of the output device 206. In the first embodiment, a screen 600A shown in FIG. 6A is displayed on the output device 206. The screen 600A is a dialog that notifies that the subscription contract is in “not yet contracted”. In addition, the screen 600A includes an OK button 601 and a close button 602. By operating the OK button 601, an account page provided by the subscription service management server 101 is capable of being opened. The account page may include, for example, a date and time that the subscription contract has become “not yet contracted” and a cause for “not yet contracted”. Examples of the cause for “not yet contracted” include a subscription contract cancellation request from the user, non-payment of a usage fee (the monthly fee), and a request to replace the printing apparatus 102. In addition, in the case where the contract state is not capable of being confirmed, the screen may transition to a guide screen that enables confirmation of the contract state. This guide screen suggests, for example, confirming that the printing apparatus 102 belongs to a network that has Internet access, confirming the contract state from the account page, and restarting the printing apparatus 102 and the terminal apparatus 103. By operating the close button 602, the screen 600A is closed. Thereafter, a screen 600B shown in FIG. 6B may be displayed. The screen 600B is a dialog that notifies that the functions of the printing apparatus 102 are unavailable and notifies of methods for reconfirming the contract state. The screen 600B includes a close button 612 that has the same function as the close button 602 on the screen 600A. It should be noted that, instead of the screen 600A, a screen 600C shown in FIG. 6C may be displayed. The screen 600C includes an operation explanation button 623, a retry button 624, and a close button 622 that has the same function as the close button 602 on the screen 600A. By operating the operation explanation button 623, as in the case where the OK button 601 is operated, an account page is capable of being opened. By operating the retry button 624, in order to reconfirm the contract state, the processing resumes from the step S304.

As described above, in the case of being determined that the subscription contract is in “contracted”, the terminal apparatus 103 is able to end the communication with the printing apparatus 102 and notify the user that the contract state of the service contract when the communication with the printing apparatus 102 ends is “contracted”. On the other hand, in the case of being determined that the subscription contract is not in “contracted”, the terminal apparatus 103 requests the printing apparatus 102 to transmit the contract information again (the terminal apparatus 103 makes a re-request to transmit the contract information with respect to the printing apparatus 102), and in the case where a predetermined time has elapsed since the terminal apparatus 103 has requested again (since the re-request has been made), the terminal apparatus 103 ends the communication with the printing apparatus 102. Then, the user is notified that the contract state of the service contract when the communication with the printing apparatus 102 ends is “not yet contracted”. In addition, in the case where it is determined that the subscription contract is not in “contracted”, and the contract information has not been received by the communication before a predetermined time has elapsed, the user is notified that the contract information that is “contracted” has not been received. In addition, in the case where it is determined that the subscription contract is not in “contracted”, and the contract information has been received before the predetermined time has elapsed, the user is notified that the contract information has been received. With such a notification, it is possible to quickly understand whether or not the printing apparatus 102, which is a subject of the subscription contract, is capable of being used under the subscription contract.

### Second Embodiment

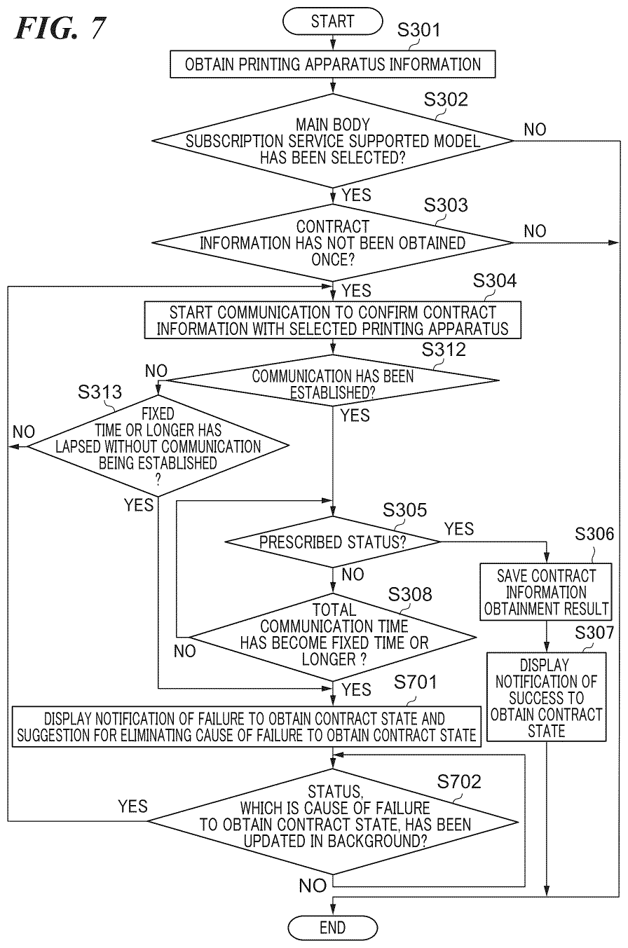

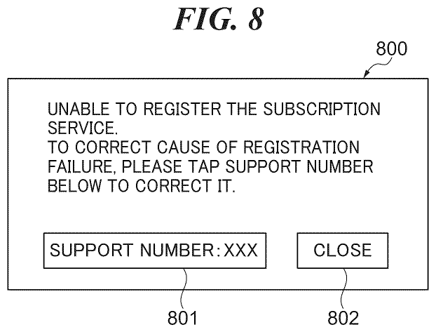

A second embodiment of the present disclosure will be described below with reference to FIG. 7 and FIG. 8. The following description will focus on the differences from the above-described first embodiment, and descriptions of the similar matters will be omitted. FIG. 7 is a flowchart that illustrates a processing executed by a terminal apparatus according to the second embodiment. FIG. 8 is a screen displayed on the terminal apparatus during execution of a program based on the flowchart illustrated in FIG. 7. In the flowchart illustrated in FIG. 7, similar to the flowchart illustrated in FIG. 3, the steps S301 to S308, S312, and S313 are executed. In the step S308, the CPU 201 determines whether or not a total communication time since the communication has been started in the step S304 has reached a fixed time or more (has become the fixed time or longer). As a result of the determination in the step S308, in the case of being determined that the total communication time has reached the fixed time or more, the processing proceeds to a step S701. On the other hand, as the result of the determination in the step S308, in the case of being determined that the total communication time has not reached the fixed time or more, the processing returns to the step S305, and the subsequent steps are executed in order.

In the step S701, the CPU 201 causes the output device 206 to display a notification of a failure to obtain the contract state. In addition to the notification of the failure to obtain the contract state, the CPU 201 causes the output device 206 to display a notification of an eliminating method (a correcting method) for eliminating the cause of non-reception of the contract information including “contracted”. The notifications in the step S701 may be a dialog display, or may be a message display in the notification area of the output device 206. In the second embodiment, a screen 800 shown in FIG. 8 is displayed on the output device 206. The screen 800 is a dialog that notifies that the subscription contract is in “not yet contracted”. In addition, the screen 800 includes a support number button (an operation unit) 801 and a close button 802 that has the same function as the close button 602 on the screen 600A. By operating the support number button 801 as an operation to instruct the execution of the eliminating method, an eliminating method corresponding to the support number is suggested. In addition, the suggestion may be made, for example, by transitioning to a link to a manual page that has been created in advance on the Internet, or by displaying a dialog, which shows the eliminating method corresponding to the support number, within the application. In the eliminating method, there are a plurality of eliminating methods for each cause. For example, in the case where the communication between the terminal apparatus 103 and the printing apparatus 102 is not successful, as an eliminating method for this case, the above-described network repair is suggested. In addition, in the case where the contract information, which is a communication result from the printing apparatus 102, includes information indicating “not yet contracted”, as an eliminating method for this case, a suggestion to confirm that the printing apparatus 102 has been contracted for the main body subscription service from the user's account page is made. After this suggestion, a suggestion to confirm that the printing apparatus 102 has been connected to the Internet is made. In addition, in the case where the screen 800 includes a button for performing the update of the contract information in the printing apparatus 102, a suggestion to operate this button is made.

In addition, in the second embodiment, although the typical examples of the contract state are “contracted” and “not yet contracted”, as described above, there are also “contract information not yet received”, “contract information being received”, and “contract forcibly suspended”. Eliminating suggestions for these cases will be described below. In the case of “contract information not yet received”, it is considered that the communication between the printing apparatus 102 and the subscription service management server 101 has not been established. As a solving method for this case, for example, a suggestion to confirm that the printing apparatus 102 has been connected to the Internet is made. In addition, in the case of “contract information being received”, it is considered that the subscription service management server 101 has not returned a response. As a solving method for this case, for example, a suggestion to confirm whether or not the subscription service management server 101 is operational on the account page is made. This operation confirmation is performed, for example, by trying to obtain the contract information and confirming whether or not the obtainment of the contract information is possible. In addition, the operation confirmation is capable of being performed based on the operation status of the subscription service management server 101 that has been described on the account page. In addition, in the case where the subscription service management server 101 is operational, an inquiry from the account page may be suggested. In addition, as a solving method for the case of “contract forcibly suspended”, for example, a suggestion to transition to the account page, confirm the cause of the forced suspension, and view the guide on how to complete “contracted” is made. After the step S701 is executed, the processing proceeds to a step S702.

In the step S702, the CPU 201 determines whether or not a status, which is the cause of the failure to obtain the contract state, has been updated in the background, that is, the CPU 201 determines whether or not the cause of the failure to obtain the contract state has been eliminated. In this way, in the second embodiment, the CPU 201 has a function as an elimination determining unit that determines whether or not the cause of the failure to obtain the contract state has been eliminated. It should be noted that in the terminal apparatus 103, a part having the function as the elimination determining unit may be provided separately from the CPU 201. As a result of the determination in the step S702, in the case of being determined that the status, which is the cause of the failure to obtain the contract state, has been updated, the processing returns to the step S304, and the subsequent steps are executed in order. In addition, in the case of being determined that the status, which is the cause of the failure to obtain the contract state, has been updated, it is possible to request the printing apparatus 102 to transmit the contract information. On the other hand, as the result of the determination in the step S702, in the case of being determined that the status, which is the cause of the failure to obtain the contract state, has not been updated, the processing remains in the step S702 and waits.

For example, in the case where the contract information has not been obtained, it is considered that the cause is that the communication between the terminal apparatus 103 and the printing apparatus 102 has not been established. As a method of confirming the status for this case, for example, there is a method in which the terminal apparatus 103 attempts background communication with the printing apparatus 102 at regular time intervals to confirm whether or not the communication with the printing apparatus is possible. In addition, as a method of confirming the status for the case of “not yet contracted”, for example, there is a method of requesting the printing apparatus 102 to transmit the contract information at regular time intervals and confirming that the result of the reception is “contracted”. In addition, the network I/F 207 of the terminal apparatus 103 is opened to the printing apparatus 102, and in the case where the contract information has been updated, an instruction to transmit information indicating that the contract information has been updated is issued. Furthermore, there is a method in which the information indicating that the contract information has been updated is used as a trigger to confirm the contract information of the printing apparatus 102. In addition, in the case where communication for the status update confirmation when performing other functions used by the user becomes a problem, it is preferable to temporarily halt the communication and resume the communication for the status update confirmation in the background at a timing when the communication becomes available.

As described above, in the second embodiment, in the case where the status is not capable of being obtained, an eliminating method corresponding to the cause is capable of being suggested. In addition, since the communication is performed in the case where the cause is eliminated, it is possible to prevent the user's operation from being stopped and prevent excessive communication from occurring.

According to the present disclosure, it is possible to quickly understand whether or not the image forming apparatus, which is the subject of the fixed-charge service contract, is capable of being used under the service contract.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115676, filed Jul. 19, 2024, which is hereby incorporated by reference herein in its entirety.

What is claimed is:

1. An information processing apparatus that is communicably connected to an image forming apparatus, which has a printing function and is a subject of a fixed-charge service contract, the information processing apparatus comprising:
at least one processor;
a memory coupled to the processor storing instructions that, when executed by the processor, cause the processor to function as:
a control unit that controls communication with the image forming apparatus; and
a requesting unit that, in a case where contract information relating to the service contract has not been obtained after a predetermined screen is displayed, requests the image forming apparatus to transmit the contract information;
a receiving unit configured to receive the contract information transmitted from the image forming apparatus in accordance with the request made by the requesting unit; and
a notifying unit configured to notify a contract state of the service contract.

2. The information processing apparatus according to claim 1, wherein
the processor is caused to further function as an obtainment determining unit that, in a case where the predetermined screen is displayed, determines whether or not the contract information has been obtained, and
as a result of the determination made by the obtainment determining unit, in a case of being determined that the contract information has not been obtained, the requesting unit requests the image forming apparatus to transmit the contract information.

3. The information processing apparatus according to claim 2, further comprising:
a storage unit configured to be capable of storing the contract information, and
wherein the obtainment determining unit determines whether or not the contract information has been obtained based on presence or absence of the contract information in the storage unit.

4. The information processing apparatus according to claim 1, wherein
the processor is caused to further function as a state determining unit that determines whether or not the service contract is in a prescribed contract state based on the contract information received by the receiving unit,
as a result of the determination made by the state determining unit, in a case of being determined that the service contract is in the prescribed contract state, the control unit ends the communication, and the notifying unit notifies that the contract state of the service contract when the communication ends is the prescribed contract state, and
as the result of the determination made by the state determining unit, in a case of being determined that the service contract is not in the prescribed contract state, the requesting unit makes a re-request to transmit the contract information with respect to the image forming apparatus, and in a case where a predetermined time has elapsed since the re-request has been made, the control unit ends the communication, and the notifying unit notifies the contract state of the service contract when the communication ends.

5. The information processing apparatus according to claim 4, wherein
the image forming apparatus is an apparatus that has a plurality of functions including the printing function, and some functions of the plurality of functions are restricted under the service contract, and
in the case of being determined that the service contract is in the prescribed contract state, the notifying unit notifies that the some functions, which have been restricted under the service contract, are capable of being used on the image forming apparatus, as information indicating that the service contract is in the prescribed contract state.

6. The information processing apparatus according to claim 4, wherein
in the case of being determined that the service contract is in the prescribed contract state, the notifying unit notifies contents of the service contract, as information indicating that the service contract is in the prescribed contract state.

7. The information processing apparatus according to claim 4, wherein
in a case where it is determined that the service contract is not in the prescribed contract state, and the contract information has not been received by the communication before the predetermined time has elapsed, the notifying unit notifies that the contract information has not been received by the receiving unit, as the contract state of the service contract when the communication ends.

8. The information processing apparatus according to claim 7, wherein
the notifying unit is capable of notifying a repair method for repairing the communication with the image forming apparatus.

9. The information processing apparatus according to claim 8, further comprising:
an operation unit configured to perform an operation to instruct execution of the repair method, and
wherein the notifying unit is capable of notifying an execution result of the repair method.

10. The information processing apparatus according to claim 7, wherein
the notifying unit notifies an eliminating method for eliminating a cause of non-reception of the contract information, as the contract state of the service contract when the communication ends.

11. The information processing apparatus according to claim 10, wherein
in the eliminating method, there are a plurality of eliminating methods for each cause, and
the processor is caused to further function as an operation unit that performs an operation to instruct execution of each of the eliminating methods.

12. The information processing apparatus according to claim 10, wherein
the processor is caused to further function as an elimination determining unit that determines whether or not the cause has been eliminated, and
as a result of the determination made by the elimination determining unit, in a case of being determined that the cause has been eliminated, the requesting unit requests the image forming apparatus to transmit the contract information.

13. The information processing apparatus according to claim 4, wherein
in a case where it is determined that the service contract is not in the prescribed contract state, and the contract information has been received by the communication before the predetermined time has elapsed, the notifying unit notifies that the contract information has been received by the receiving unit, as the contract state of the service contract when the communication ends.

14. The information processing apparatus according to claim 4, wherein
lapse of the predetermined time since the re-request has been made in the case of being determined that the service contract is not in the prescribed contract state is capable of being changed to a predetermined number of times of execution of the re-request.

15. The information processing apparatus according to claim 1, wherein
the service contract is a subscription contract.

16. An information processing system comprising:
an image forming apparatus that has a printing function and is a subject of a fixed-charge service contract; and
an information processing apparatus that is communicably connected to the image forming apparatus, and
wherein the information processing apparatus comprises
at least one processor;
a memory coupled to the processor storing instructions that, when executed by the processor, cause the processor to function as:
a control unit that controls communication with the image forming apparatus; and
a requesting unit that, in a case where contract information relating to the service contract has not been obtained after a predetermined screen is displayed, requests the image forming apparatus to transmit the contract information;
a receiving unit configured to receive the contract information transmitted from the image forming apparatus in accordance with the request made by the requesting unit; and
a notifying unit configured to notify a contract state of the service contract.

17. A control method for controlling an information processing apparatus that is communicably connected to an image forming apparatus, which has a printing function and is a subject of a fixed-charge service contract, the control method comprising:
a control step of controlling communication with the image forming apparatus;
a requesting step of, in a case where contract information relating to the service contract has not been obtained after a predetermined screen is displayed, requesting the image forming apparatus to transmit the contract information;
a receiving step of receiving the contract information transmitted from the image forming apparatus in accordance with the request made in the requesting step; and
a notifying step of notifying a contract state of the service contract.

18. A non-transitory computer-readable storage medium storing a program for causing a computer to execute a control method for controlling an information processing apparatus that is communicably connected to an image forming apparatus, which has a printing function and is a subject of a fixed-charge service contract, the control method comprising:
a control step of controlling communication with the image forming apparatus;
a requesting step of, in a case where contract information relating to the service contract has not been obtained after a predetermined screen is displayed, requesting the image forming apparatus to transmit the contract information;
a receiving step of receiving the contract information transmitted from the image forming apparatus in accordance with the request made in the requesting step; and
a notifying step of notifying a contract state of the service contract.
